(19) United States
(12) Patent Application Publication
(10) Pub. No.: US 2005/0092111 A1
(43) Pub. Date: May 5, 2005

(54) Non-destructive diagnostic apparatus for identifying defect type in core composite structures

(76) Inventors: David N. Schmaling, Southbury, CT (US); David A. Darrow, Hamden, CT (US)

Correspondence Address: CARLSON, GASKEY & OLDS, P.C., 400 WEST MAPLE ROAD, SUITE 350, BIRMINGHAM, MI, 48009, US

(21) Appl. No.: 10/701,270

(22) Filed: Nov. 4, 2003

(51) Int. Cl. G01M 19/00; G01N 3/00; G01N 3/02

(52) U.S. Cl. 73/865.9; 73/866; 73/802; 73/794

(57) ABSTRACT

A diagnostic tool that determines the type of defect present in a core composite sandwich structure. The diagnostic tool is portable and non-destructive. The diagnostic tool locally generates and records load versus displacement measurements for the core composite sandwich skin, in both the tension and compression directions. These values are then compared to similar measurements taken in a non-discrepant area of the structure. Defect type is determined based on the differences in the load/displacement behavior between the non-discrepant and discrepant locations.

### BACKGROUND OF THE INVENTION

The present invention relates to a diagnostic tool and method, therefor and more particularly to a diagnostic tool and method which identifies and differentiates between skin-to-core disbonds and core failures within a core composite structure.

Core composite structures such as honeycomb core sandwich structures with thin composite or metal skins are used throughout the aerospace industry for airframe, rotor and wing structures. The typical defects or failure modes in these structures are skin-to-core disbonds or core failures such as core crushing or crimpling. Each of these defects requires a different corrective action.

A skin-to-core failure is typically repaired by drilling holes in the skin and partially filling the cells with adhesive. The holes are then covered and the structure inverted such that the adhesive flows into the disbonded area. Following cure, the small injection holes are repaired using a patch material similar to the skin material.

A core crush requires the removal of a large piece of skin, removal of the defective core, and subsequent replacement of the skin and core. A large patch is then used which overlaps the repaired area as well as the joint between the repaired area and the surrounding structure. The core crush repair may be more difficult and time consuming than the skin-to-core bond repair; but core crushes are typically found to be less structurally critical than skin-to-core disbonds (the degraded core partially performs its function, while a disbanded skin must transmit the loads independent of the core).

The size of a defect that is acceptable depends on the type of defect present (i.e. for the H-60 Blackhawk main rotor blade, core crushes up to 3.0 square inches do not require repair, but skin-to-core disbonds up to 2.0 square inches must be repaired). To determine whether a repair is needed and what type of repair to perform, it is useful to know the type of defect at the time of inspection.

Inspection techniques for structures of this type usually consist of the “coin tap” method or through-transmission ultrasonic methods. The “coin tap” method is commonly utilized in the field, while ultrasonic methods are typically performed at more fully equipped maintenance areas.

Both inspection methods are effective at detecting defects. However, no inspection method currently available has the ability to differentiate between a skin-to-core failure and a core crush. With the current inspection approach, it is necessary to assume that the worst type of defect is present (skin-to-core disbond), and replace the component when the allowable defect limit is reached. In order to determine the type of repair required, a relatively complicated core plug tension test is usually performed in the discrepant area, and, if the defect is not a skin-to-core disbond, the structure may be patched (and returned to service) until the higher defect size is reached. In most cases, however, the core is conservatively repaired at the time of the core plug test, and then returned to service.

Accordingly, it is desirable to provide an inexpensive non-destructive diagnostic system and method which may be utilized in the field to determine the type of defect and thereby minimize vehicle down time.

### SUMMARY OF THE INVENTION

The diagnostic tool according to the present invention determines the type of defect present in a core composite sandwich structure. The diagnostic tool is portable and non-destructive. The diagnostic tool locally generates and records load versus displacement measurements for the core composite sandwich skin, in both the tension and compression directions. These values are then compared to similar measurements taken in a non-discrepant area of the structure. Defect type is determined based on the differences in the load/displacement behavior between the non-discrepant and discrepant areas.

A properly formed structure has a linear load displacement behavior in both the tension and compression directions. Structures with a crushed core or disbanded skins will have unique behavior depending on the direction of loading. For a crushed core defect, the structure will behave linearly in the compression direction (with greatly reduced stiffness compared to a non-discrepant structure), and stepwise linear in the tension direction; the core will have low tensile stiffness until the crushed cells are straightened, and then the stiffness becomes generally identical to a non-discrepant structure. When the skin is disbonded, the stiffness will behave identical to a non-discrepant structure in the compression direction and will behave linearly (with reduced stiffness) in the tension direction. These cases can be summarized as follows:
(1) reduced stiffness in the compression direction implies core crushing;
(2) reduced stiffness in the tension direction, followed by step-wise linear stiffness behavior confirms core crushing (and no skin-to-core disbond); and
(3) reduced stiffness in the tension direction (without “step-wise” behavior) implies skin-to-core bond failure.

The present invention therefore provides an inexpensive non-destructive diagnostic system and method which may be utilized in the field to determine the type of defect and thereby minimize vehicle down time.

### BRIEF DESCRIPTION OF THE DRAWINGS

The various features and advantages of this invention will become apparent to those skilled in the art from the following detailed description of the currently preferred embodiment. The drawings that accompany the detailed description can be briefly described as follows:

FIG. 1 is a general perspective view of a diagnostic tool designed according to the present invention;

FIG. 2 is a partial phantom view of a diagnostic tool;

FIG. 3 is a sectional view of a diagnostic tool;

FIG. 4A is a sectional schematic view of a core composite structure with a defect area;

FIG. 4B is a sectional schematic view of a core composite structure with a defect area under a compressive force from the diagnostic tool;

FIG. 4C is a sectional schematic view of a core composite structure with a defect area under a tension force from the diagnostic tool;

FIG. 4D is a sectional schematic view of a core composite structure with a defect area under a tension force from the diagnostic tool illustrating a skin to core disbond;

FIG. 5 is a graphical representation of a load/displacement behavior between a non-discrepant and discrepant core composite structure as determined by the present invention.

### DETAILED DESCRIPTION OF THE PREFERRED EMBODIMENT

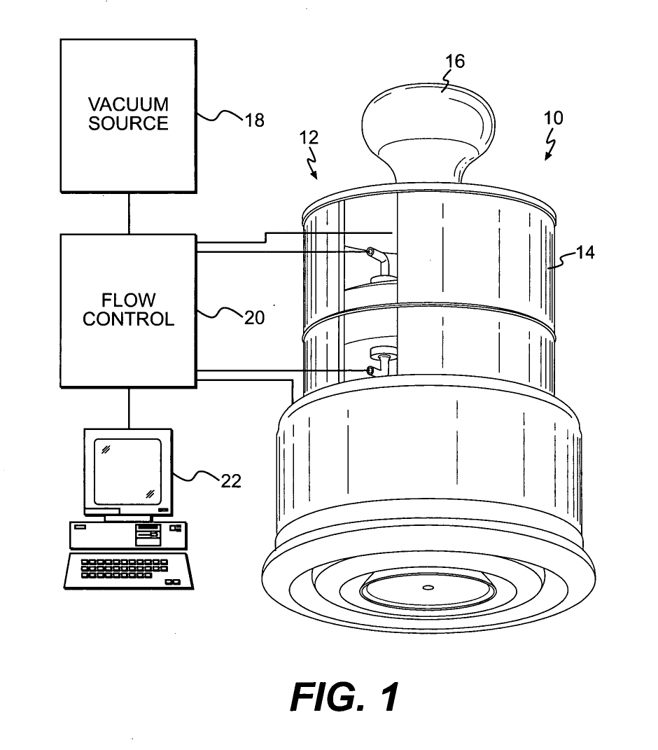

FIG. 1 illustrates a general perspective view of a diagnostic system 10 which determines the type of defect present in a core composite sandwich structure. The system 10 includes a hand-held diagnostic tool 12 which includes a housing 14 and a handle 16. The tool 12 is powered by a vacuum source 18 (illustrated schematically) which communicates with the tool 12 through a flow control manifold 20 (illustrated schematically) which is operated by a controller 22. Preferably, the vacuum source 18 is available from common sources such as a typical shop vacuum or the like. The controller 22 is preferably a conventional laptop or desktop computer running software to collect and record data for instantaneous and later analysis. It should be understood that the components may alternatively or additionally be integrated into a single device.

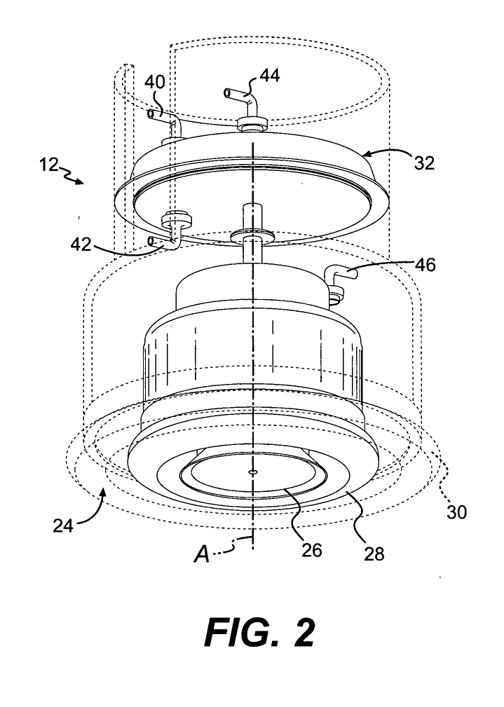

Referring to FIG. 2, the tool 12 includes a seal assembly 24 and an attachment 26. The seal assembly 24 includes an inner seal 28 and an outer seal 30. The attachment 26 is located within the inner seal 28 and is preferably attached through a vacuum-assist. The attachment 26 is movable along axis A in response to a vacuum cylinder 32 which drives the vacuum assisted attachment 26 relative to the seal assembly 24. It should be understood that attachment devices other than vacuum-assist will also benefit from the present invention.

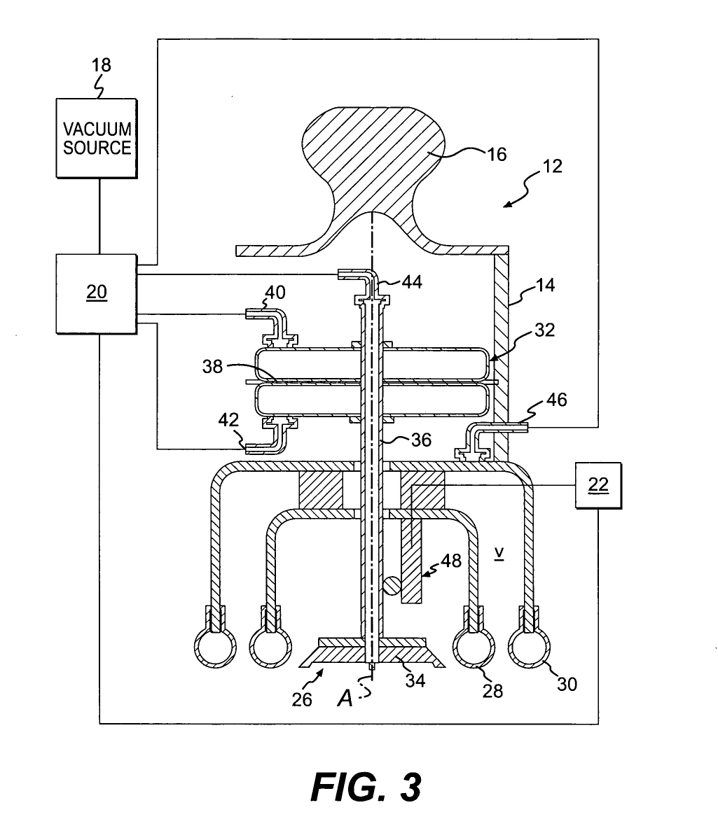

Referring to FIG. 3, the attachment 26 preferably includes a vacuum-assisted suction cup 34 mounted to a hollow shaft 36. The vacuum cylinder 32 includes a piston 38 which is connected to the shaft 36 to drive the vacuum assisted attachment 26 along the axis A in response to a suction applied to a selected side of the piston 38 within the vacuum cylinder 32.

The vacuum source 18 communicates through the flow control manifold 20 with the tool 12 through a tension vacuum port 40 in communication with the vacuum cylinder 32 on a first side of the piston 38 and a compression vacuum port 42 in communication with the vacuum cylinder 32 on a second side of the piston 38, an attachment vacuum port 44 in communication with the suction cup 34 through the hollow shaft 36, and a seal assembly vacuum port 46 (also illustrated in FIG. 2) in communication with a volume V between the inner seal 28 and the outer seal 30.

sensor 48 such as a Linear Variable Differential Transformer (LVDT) is preferably located adjacent the shaft 36 to measure linear displacement thereof. The sensor 48 communicates displacement to the controller 22 for recordation and analysis. It should be understood that other sensors and/or positions will also benefit from the present invention.

A method for utilizing the system 10 to detect a defect in a honeycomb core composite structure C such as a rotor blade will now be described. However, it should be realized that the use of a honeycomb core structure is for illustrative purposes only, and that the methodology of the present invention may be applied to other core composite structures.

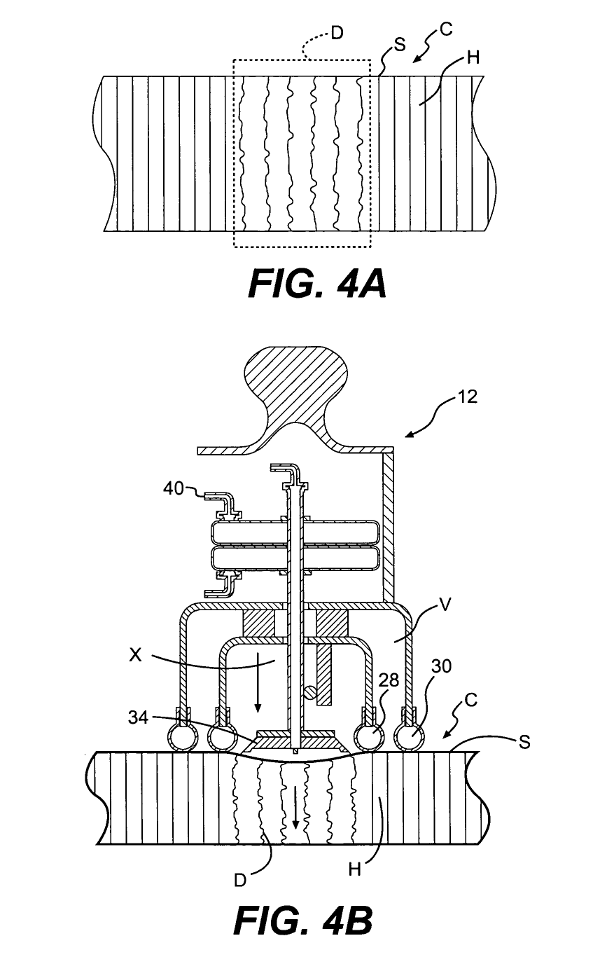

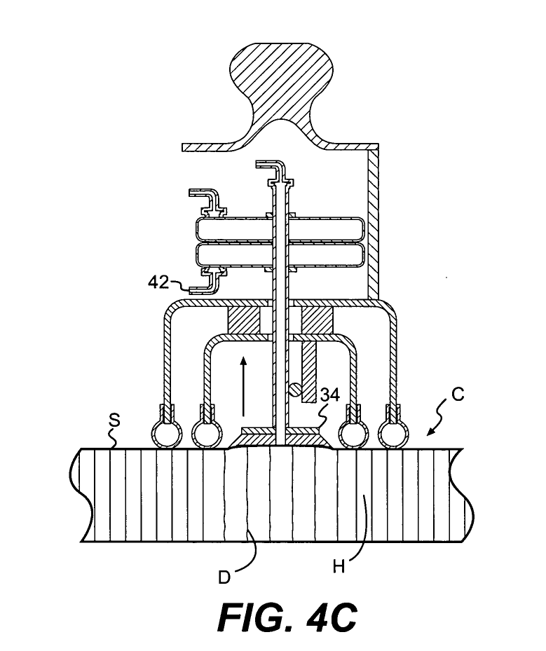

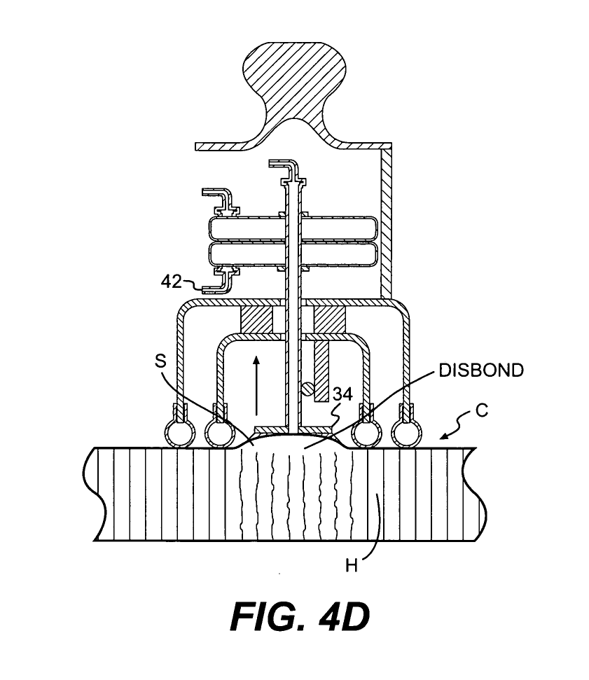

Referring to FIG. 4A, a core composite structure C includes a honeycomb core H and a skin S applied thereto. Here, the core H is damaged at location D. Although the general location of the defect D is known through conventional inspection methods, the type of defect would heretofore be unknown without cutting through the skin S.

Referring to FIG. 4B, the tool 12 is secured to the structure C through application of a vacuum in the volume V between the seals 28,30 of the seal assembly 24 through the seal assembly vacuum port 46 which affixes the tool 12 thereto. The suction cup 34 is also secured to the structure C by application of a vacuum to the attachment vacuum port 44. The area of the suction cup 34 is preferably 1 sq. in., which will allow a tension load of 14.7 lbs to be applied to the structure. Loads greater than this may be damaging to a non-discrepant core structure. The larger area between the two seals 28, 30 will allow compressive loads of higher value to be applied to the structure, without the tool 12 breaking free of the surface. The core H is typically capable of carrying higher loads in the compressive direction.

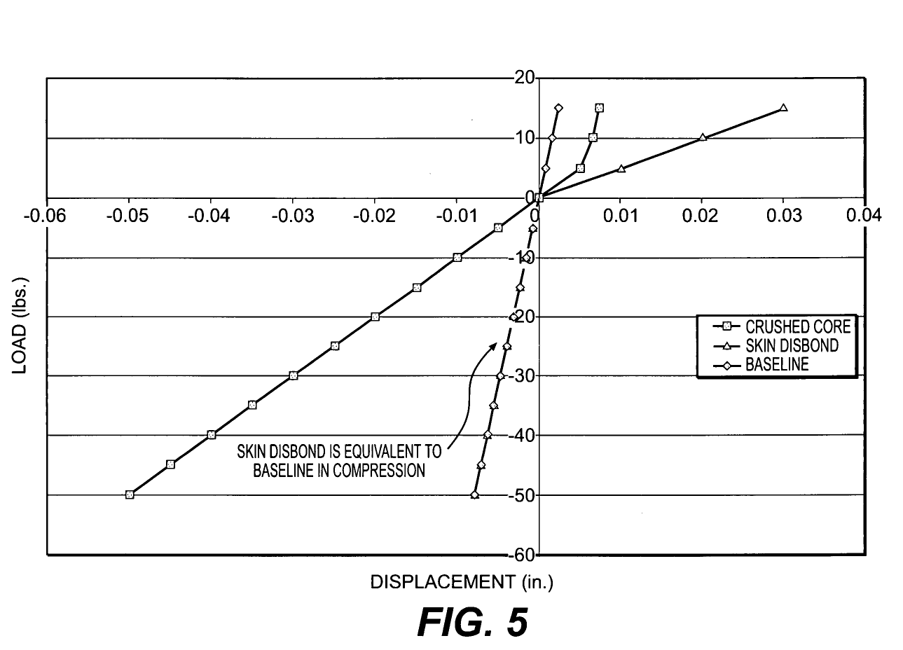

Once the tool 12 is secured to the structure C, a vacuum is applied to the compression vacuum port 42, such that the suction cup 34 is driven toward the core H (schematically illustrated by arrow X). It should be understood that the displacement is exaggerated for disclosure purposes. The sensor 48 measures the displacement and the controller 22 relates the displacement to the load (FIG. 5). A reduced stiffness in the compression direction implies that the core H is crushed. That is, the reduction is as compared to an undamaged section of the structure C. Data from undamaged sections are preferably previously sampled and stored as a baseline (FIG. 5) for later comparison.

Referring to FIG. 4C, vacuum is applied to the tension vacuum port 40, such that the suction cup 34 and attached skin S is retracted away from the core H, such that the skin S is pulled. The sensor 48 measures the displacement and the controller 22 relates the displacement to the load (FIG. 5). Reduced stiffness in the tension direction, followed by non-discrepant linear stiffness behavior confirms core crushing and no skin-to-core disbond. That is, the suction cup 34 essentially pulls the crush D out of the core H such that the honeycomb in the damaged area is straightened and then the tension is resisted by the core H as the skin S is properly bonded thereto.

Referring to FIG. 4D, the sensor 48 continues to measures displacement and the controller 22 relates the displacement to the load (FIG. 5) such that a reduced stiffness in the tension direction (without “step-wise” behavior of FIG. 4C) implies that a skin-to-core bond failure. That is, the suction cup 34 pulls the skin away from the core H as the skin is not properly bonded thereto. This behavior is generally linear (with reduced stiffness) without the step-wise behavior.

Although particular step sequences are shown, described, and claimed, it should be understood that steps may be performed in any order, separated or combined unless otherwise indicated and will still benefit from the present invention.

The foregoing description is exemplary rather than defined by the limitations within. Many modifications and variations of the present invention are possible in light of the above teachings. The preferred embodiments of this invention have been disclosed, however, one of ordinary skill in the art would recognize that certain modifications would come within the scope of this invention. It is, therefore, to be understood that within the scope of the appended claims, the invention may be practiced otherwise than as specifically described. For that reason the following claims should be studied to determine the true scope and content of this invention.

1. A diagnostic system for a core composite structure comprising:
a seal assembly;
an attachment movable relative to said seal assembly; and
a sensor operable to determine relative movement of said attachment.

2. The diagnostic system as recited in claim 1, wherein said seal assembly comprises a vacuum seal.

3. The diagnostic system as recited in claim 1, wherein said attachment comprises a vacuum-assisted suction cup.

4. The diagnostic system as recited in claim 1, wherein said sensor comprises an Linear Variable Differential Transformer (LVDT).

5. The diagnostic system as recited in claim 1, wherein said vacuum assisted attachment is located within said seal assembly.

6. The diagnostic system as recited in claim 1, further comprising a vacuum cylinder attached to said vacuum assisted attachment.

7. The diagnostic system as recited in claim 6, wherein said vacuum cylinder drives said vacuum assisted attachment relative to said seal assembly.

8. A diagnostic system for a core composite structure comprising:
a seal assembly comprising an outer seal and an inner seal;
a vacuum-assisted attachment located within said inner seal, said vacuum-assisted attachment movable along an axis relative to said seal assembly;
a vacuum cylinder comprising a piston attached to said vacuum assisted attachment; and
a sensor operable to determine relative movement of said vacuum assisted attachment.

9. The diagnostic system as recited in claim 8, wherein said vacuum assisted attachment comprises a suction cup mounted to a hollow shaft, said hollow shaft mounted to said piston.

10. The diagnostic system as recited in claim 9, further comprising a tension vacuum port in communication with said vacuum cylinder on a first side of said piston and a compression vacuum port in communication with said vacuum cylinder on a second side of said piston.

11. The diagnostic system as recited in claim 9, further comprising an attachment vacuum port in communication with said suction cup through said hollow shaft.

12. The diagnostic system as recited in claim 8, further comprising a seal assembly vacuum port in communication with a volume between said outer seal and said inner seal.

13. The diagnostic system as recited in claim 8, wherein said vacuum assisted attachment comprises a one square inch suction cup.

14. A method of determining a defect type within a core composite structure comprising the steps of:
(1) affixing a seal assembly to a skin of a core composite structure;
(2) affixing an attachment to the skin of the core composite structure;
(3) displacing the attachment relative to the seal assembly; and
(4) relating said step (3) to said step (2) to determine a defect type within the core composite structure.

15. A method as recited in claim 14, wherein said step (3) further comprises applying a vacuum to displace the attachment.

16. A method as recited in claim 14, wherein said step (4) further comprises relating an applied load relative a linear displacement.

17. A method as recited in claim 14, further comprising the steps of:
(a) identifying a stiffness reduction in a compression direction.

18. A method as recited in claim 17, further comprising the steps of:
(b) identifying a stiffness reduction in a tension direction; and
(c) identifying a non-linear stiffness increase in the tension direction.

19. A method as recited in claim 17, further comprising the steps of:
(b) identifying a stiffness reduction in a tension direction; and
(c) identifying a linear stiffness increase in the tension direction.

20. A method as recited in claim 14, further comprising the steps of:
comparing a first applied load relative to a first linear displacement at a first location on the core composite structure to a second applied load relative to a second linear displacement at a second location on the core composite structure.

21. A method as recited in claim 14, wherein said step (1) further comprises applying a vacuum within the seal assembly to affix the seal assembly to the skin.

22. A method as recited in claim 14, wherein said step (2) further comprises applying a vacuum within the attachment to affix the attachment to the skin.
